(19) United States
(12) Patent Application Publication
(10) Pub. No.: US 2019/0391556 A1
(43) Pub. Date: Dec. 26, 2019

(54) NUMERICAL CONTROLLER

(71) Applicant: Fanuc Corporation, Yamanashi (JP)

(72) Inventor: Hideki Kuroki, Minamitsuru-gun (JP)

(73) Assignee: Fanuc Corporation, Yamanashi (JP)

(21) Appl. No.: 16/447,235

(22) Filed: Jun. 20, 2019

(30) Foreign Application Priority Data
Jun. 26, 2018 (JP) 2018-121334

(51) Int. Cl. G05B 19/19; G05B 19/402; G05B 19/416

(52) U.S. Cl. CPC G05B 19/19; G05B 19/416; G05B 19/402

(57) ABSTRACT

A numerical controller for moving a movable object by axis control includes a distance determination unit for setting at least one of a feed speed or an in-position width in accordance with a distance between an interference area where entry of the movable object is prohibited and the movable object. According to this configuration, a numerical controller capable of controlling a speed in consideration of an interference area is provided.

### RELATED APPLICATION

The present application claims priority to Japanese Application Number 2018-121334 filed Jun. 26, 2018, the disclosure of which is hereby incorporated by reference herein in its entirety.

### BACKGROUND OF THE INVENTION

### 1. Field of the Invention

The application relates to a numerical controller, and particularly relates to a numerical controller capable of controlling a speed in consideration of an interference area.

### 2. Description of the Related Art

In a machine (an industrial machine such as a machine tool) controlled by a numerical controller, a time lag usually occurs between output of a program (machining program, hereinafter simply referred to as a program) command and operation of a servo. This time lag is referred to as a servo delay. The servo delay causes a gap between a machining path presumed by the program and an actual machining path. The servo delay increases in proportion to a feed speed. For this reason, when the feed speed is large, as illustrated in a left drawing of FIG. 1, inward turning due to the servo delay is likely to occur at a corner etc., and an interferer including a workpiece or each part of the machine is present. In this way, a tool may enter an area (interference area) where the tool is not desired to enter.

To cope with such a problem, conventionally, the feed speed or an in-position width (a range in which it is considered that the tool has reached a block end point defined by the program) in the vicinity of the interference area has been manually set by considering inward turning due to the servo delay beforehand (see a right drawing of FIG. 1). As the feed speed or the in-position width is decreased, the gap due to the servo delay can be decreased. However, a cycle time extends in contradiction thereto.

Japanese Patent Laid-Open No. 05-313729 is present as a conventional art related to avoidance of collision with an interferer. A numerical controller described in Japanese Patent Laid-Open No. 05-313729 changes the in-position width in accordance with a corner angle between blocks, thereby keeping a corner error within an allowable range.

In a scheme of manually setting the feed speed and the in-position width, these settings should be taken into consideration each time processing is performed in the vicinity of the interference area, which is significantly complicated.

When a scheme described in Japanese Patent Laid-Open No. 05-313729 is adopted, the feed speed and the in-position width are automatically set to satisfy a tolerance at the corner. For example, when such control is implemented at the corner near the interference area (see FIG. 2), the interference can be avoided by a trade-off with a cycle time, which may be useful. However, such control is unnecessary outside the vicinity of the interference area (see FIG. 2), and there is a problem that the cycle time is unnecessarily extended when such control is performed.

### SUMMARY OF THE INVENTION

The application is made to solve such a problem, and an object of the application is to provide a numerical controller capable of controlling a speed in consideration of an interference area.

A numerical controller according to embodiments of the application is a numerical controller for moving a movable object by axis control, including a distance determination unit for setting at least one of a feed speed or an in-position width in accordance with a distance between an interference area where entry of the movable object is prohibited and the movable object.

In the numerical controller according to embodiments of the application, the distance determination unit sets a feed speed override or an in-position width to be smaller in a case in which the movable object is located in a vicinity of the interference area provided in a certain range of a periphery of the interference area than in a case in which the movable object is located outside the vicinity of the interference area.

In the numerical controller according to embodiments of the application, the distance determination unit provides a plurality of areas having different distances from the interference area in a periphery of the interference area, and sets a feed speed override or an in-position width to be smaller as an area in which the movable object is located is closer to the interference area.

In the numerical controller according to embodiments of the application, the distance determination unit determines a movement direction of the movable object on the basis of a current position of the movable object and a position of the movable object in a subsequent control cycle, and sets at least one of the feed speed or the in-position width in accordance with the movement direction.

In the numerical controller according to embodiments of the application, when the movable object moves in a direction in which a distance from the interference area increases, the distance determination unit does not perform setting for the feed speed or the in-position width.

In the numerical controller according to embodiments of the application, when the movable object moves in a direction in which a distance from the interference area decreases, the distance determination unit sets the feed speed override or the in-position width to be smaller as the distance is smaller.

According to the application, it is possible to provide a numerical controller capable of controlling a speed in consideration of an interference area.

### BRIEF DESCRIPTION OF THE DRAWINGS

The above-described object and characteristic of the application and other objects and characteristics will be clear from description of embodiments below with reference to accompanying drawings. In the drawings:

FIG. 1 is a diagram describing a problem in a conventional numerical controller;

FIG. 2 is a diagram describing a problem in a conventional numerical controller;

FIG. 3 is a diagram illustrating a hardware configuration example of a numerical controller;

FIG. 4 is a diagram illustrating a functional configuration example of the numerical controller;

FIG. 5 is a diagram illustrating an operation example of the numerical controller;

FIG. 6 is a diagram illustrating an operation example of the numerical controller;

FIG. 7 is a diagram illustrating an operation example of the numerical controller;

FIG. 8 is a diagram illustrating an operation example of the numerical controller;

FIG. 9 is a diagram illustrating an operation example of the numerical controller;

FIG. 10 is a diagram illustrating an operation example of the numerical controller; and

FIG. 11 is a diagram illustrating an operation example of the numerical controller.

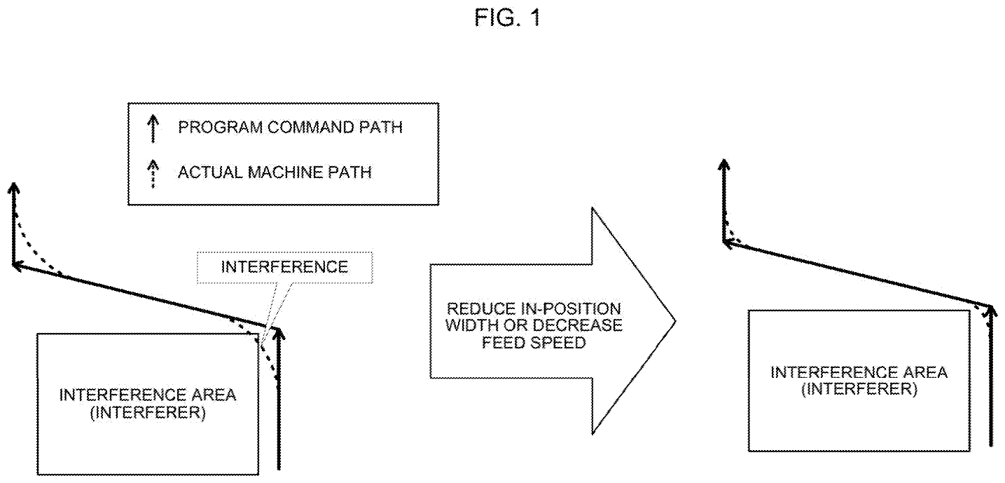

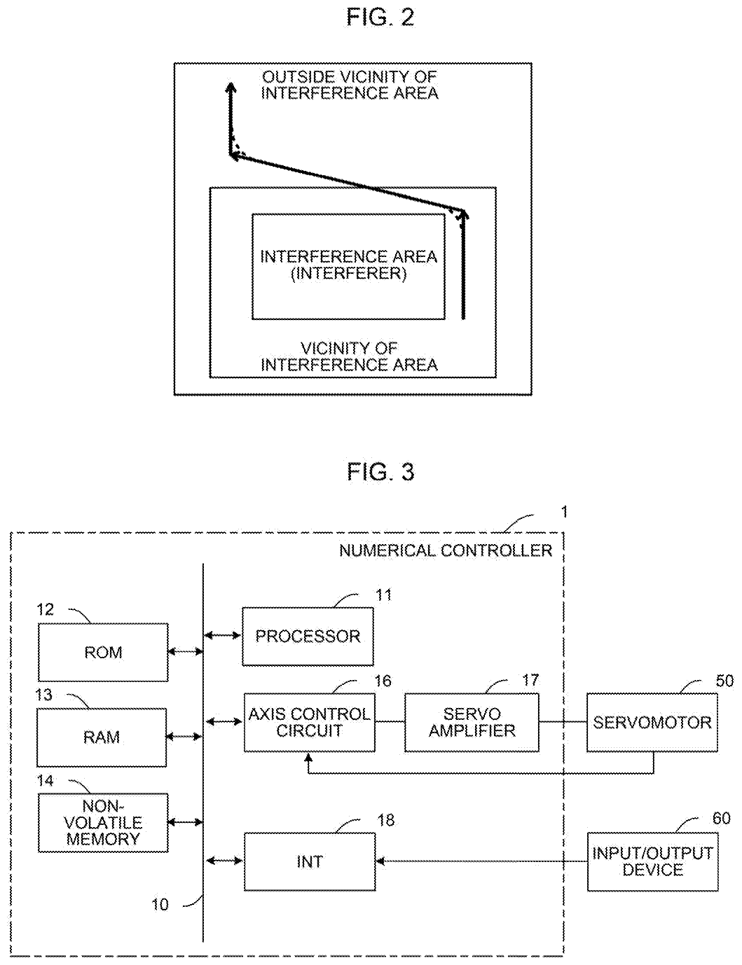

### DETAILED DESCRIPTION OF THE PREFERRED EMBODIMENTS

FIG. 3 is a schematic hardware configuration diagram illustrating a main part of a numerical controller 1 according to embodiments of the application. The numerical controller 1 is a device that reads a program and controls a machine. The numerical controller 1 includes a processor 11, a read only memory (ROM) 12, a random access memory (RAM) 13, anon-volatile memory 14, an interface 18, a bus 10, an axis control circuit 16, and a servo amplifier 17. For example, an input/output device 60 is connected to the interface 18.

The processor 11 is a processor that controls the numerical controller 1 as a whole. The processor 11 reads a system program stored in the ROM 12 via the bus 10, and controls the entire numerical controller 1 according to the system program.

The ROM 12 stores in advance a system program for executing various controls of a machine.

The RAM 13 temporarily stores temporary calculation data or display data, data input by an operator via the input/output device 60 described below, etc.

The non-volatile memory 14 is backed up by, for example, a battery (not illustrated), and retains a storage state even when a power of the numerical controller 1 is shut off. For example, the program is stored in the non-volatile memory 14.

The axis control circuit 16 controls an operation axis of the machine. The axis control circuit 16 receives an axis movement command amount output from the processor 11 and outputs an axis movement command to the servo amplifier 17.

The servo amplifier 17 receives the axis movement command output from the axis control circuit 16, and drives a servomotor 50.

The servomotor 50 is driven by the servo amplifier 17 to move the operation axis of the machine. The servomotor 50 typically incorporates a position/speed detector. The position/speed detector outputs a position/speed feedback signal, and this signal is fed back to the axis control circuit 16, thereby performing position/speed feedback control.

FIG. 3 illustrates only one axis control circuit 16, one servo amplifier 17, and one servomotor 50. However, in practice, each of the number of axis control circuits 16, the number of servo amplifiers 17, and the number of servomotors 50 to be prepared corresponds to the number of axes included in the machine. For example, in the case of controlling the machine including six axes, a total of six sets of the axis control circuits 16, the servo amplifiers 17, and the servomotors 50 corresponding to the respective axes are prepared.

The input/output device 60 is a data input/output device provided with a display, a hardware key, etc. The input/output device 60 displays information received from the processor 11 via the interface 18 on a display. The input/output device 60 delivers a command, data, etc. input from the hardware key, etc. to the processor 11 via the interface 18.

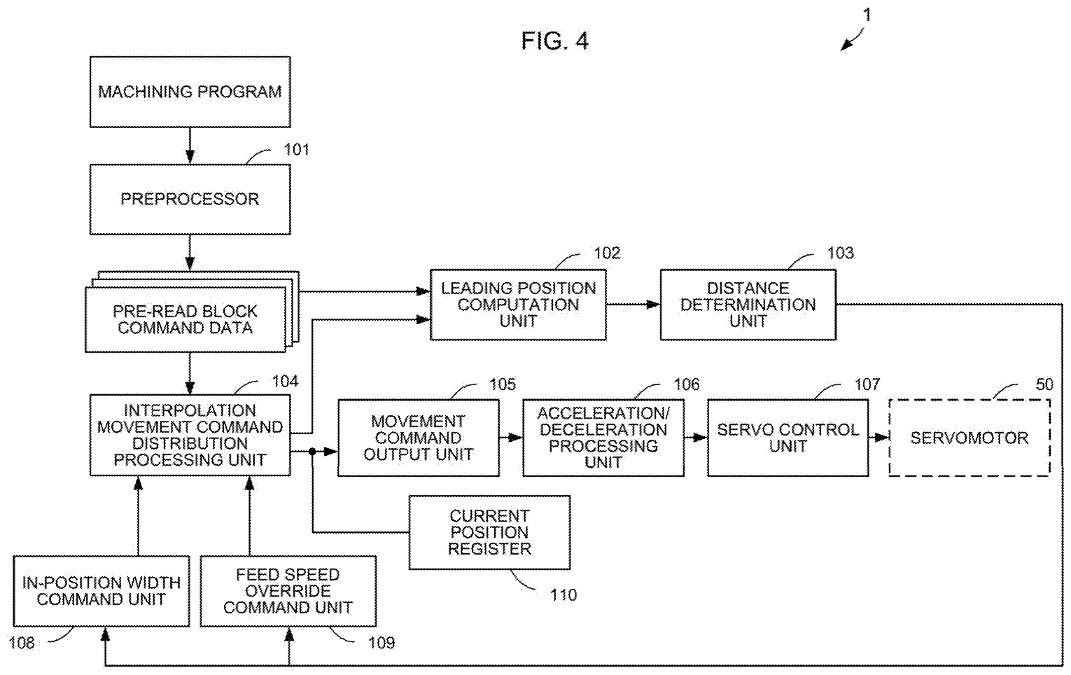

FIG. 4 is a schematic functional block diagram of the numerical controller 1 in the present embodiment. The numerical controller 1 includes a preprocessor 101, a leading position computation unit 102, a distance determination unit 103, an interpolation movement command distribution processing unit 104, a movement command output unit 105, an acceleration/deceleration processing unit 106, a servo control unit 107, an in-position width command unit 108, a feed speed override command unit 109, and a current position register 110.

The preprocessor 101 reads and interprets a program.

The leading position computation unit 102 pre-reads a program and computes a tool position in a subsequent control cycle.

The distance determination unit 103 determines whether to change the in-position width or the feed speed on the basis of a distance between the interference area and the tool.

The interpolation movement command distribution processing unit 104 pre-reads a program as necessary, and performs interpolation processing and axis distribution processing.

The movement command output unit 105 outputs each axis movement command of the machine.

The acceleration/deceleration processing unit 106 performs acceleration/deceleration processing on the movement command output by the movement command output unit 105.

The servo control unit 107 drives the servomotor 50 of each axis of the machine on the basis of the movement command on which acceleration/deceleration processing is performed by the acceleration/deceleration processing unit 106.

The in-position width command unit 108 changes a set value of the in-position width in accordance with a predetermined condition when the distance determination unit 103 determines that the in-position width should be changed.

The feed speed override command unit 109 changes an override of the feed speed in accordance with a predetermined condition when the distance determination unit 103 determines that the feed speed should be changed.

The current position register 110 retains a tool position in a current control cycle.

### Example 1

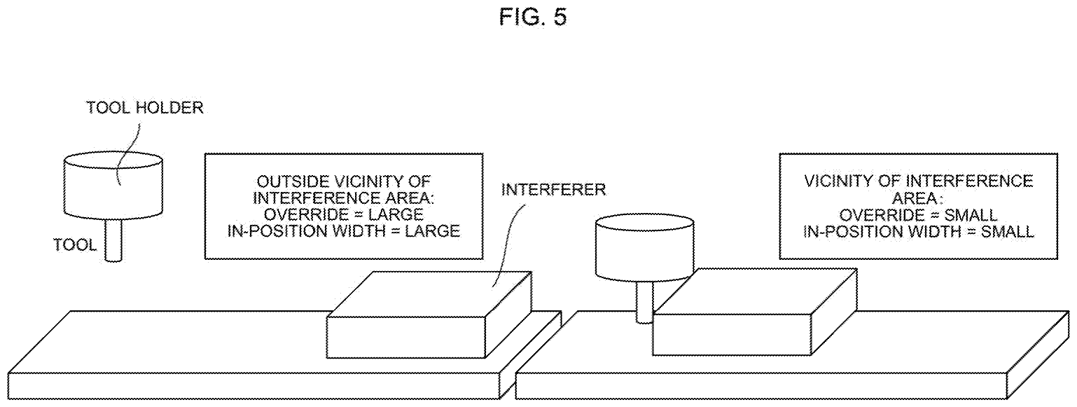

The numerical controller 1 according to the present embodiment controls the feed speed and the in-position width in accordance with a distance to the interference area. FIG. 5 is a diagram illustrating an outline of an operation of the numerical controller 1 in Example 1. When the tool is present in the vicinity of the interference area (right drawing of FIG. 5), the numerical controller 1 according to Example 1 sets at least one of the feed speed and the in-position width smaller than that in a case in which the tool is present outside the vicinity of the interference area (left drawing of FIG. 5).

The operation of the numerical controller 1 will be described over time according to FIG. 4. The numerical controller 1 repeatedly executes processing of step 1 to step 3 for each control cycle.

Step 1: The preprocessor 101 reads a program from the non-volatile memory 14, etc. and interprets the program.

Step 2: The interpolation movement command distribution processing unit 104 performs interpolation processing and axis distribution processing. In this instance, when the in-position width output by the in-position width command unit 108 and the feed speed override output by the feed speed override command unit 109 can be obtained, the interpolation movement command distribution processing unit 104 reflects the in-position width and the speed override in the movement command.

In response thereto, the movement command output unit 105 outputs each axis movement command of the machine. The acceleration/deceleration processing unit 106 performs acceleration/deceleration processing on the movement command output by the movement command output unit 105. The servo control unit 107 drives the servomotor 50 of each axis of the machine on the basis of the movement command on which acceleration/deceleration processing is performed by the acceleration/deceleration processing unit 106.

Step 3: In parallel to processing of step 2, the leading position computation unit 102 pre-reads the program and computes the tool position in the subsequent control cycle.

The distance determination unit 103 controls at least one of the feed speed and the in-position width in accordance with whether the tool position in the subsequent control cycle is within the interference area or outside the interference area. Next, an example of a specific control scheme is shown.

It is presumed that the distance determination unit 103 retains a feed speed override Oin and an in-position width Iin corresponding to a case in which the tool position is in the vicinity of the interference area and an override Oout and an in-position width Iout corresponding to a case in which the tool position is outside the vicinity of the interference area in a database, a setting file, etc. in advance. Here, Oin<Oout and Iin<Tout.

In addition, it is presumed that the distance determination unit 103 specifies the interference area and the vicinity of the interference area in advance. For example, the distance determination unit 103 can specify the following areas as the interference area.
An area in which a part of the machine is present. Typically, the numerical controller 1 retains the area.
An area in which a workpiece is present. Typically, the area is described in a program.
An interference area input by the operator.

The distance determination unit 103 computes the vicinity of the interference area by adding a certain margin to a periphery of the interference area specified in this way.

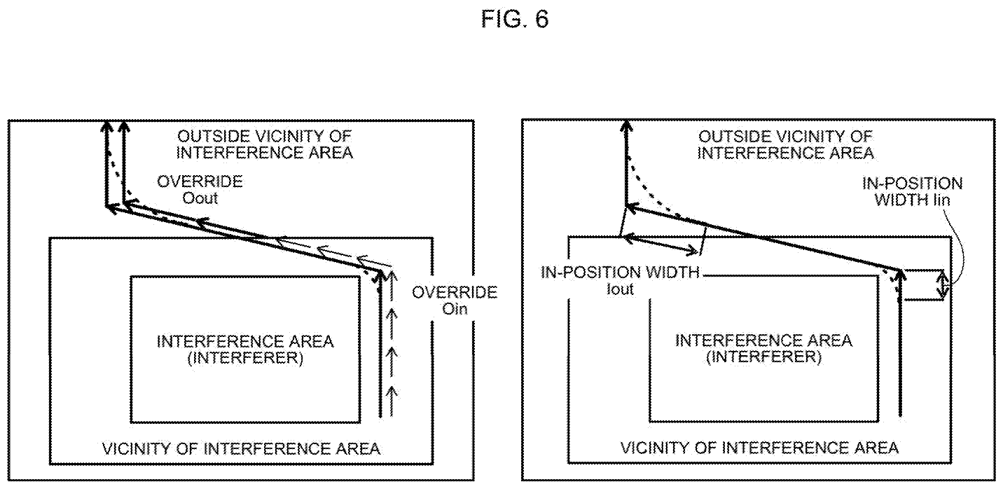

When the tool position in the subsequent control cycle is located in the vicinity of the interference area, the distance determination unit 103 causes the feed speed override command unit 109 to output Oin as an override of the feed speed in the subsequent control cycle. On the other hand, when the tool position in the subsequent control cycle is located outside the vicinity of the interference area, the feed speed override command unit 109 is caused to output Oout as the feed speed override in the subsequent control cycle. In this way, in the vicinity of the interference area, the feed speed is set to be small when compared to the outside of the vicinity of the interference area, and thus a gap due to a servo delay becomes small, and interference can be avoided. Alternatively, even when interference occurs, damage at the time of interference can be suppressed. On the other hand, on the outside of the vicinity of the interference area, the feed speed is set to be large when compared to the vicinity of the interference area, and thus a cycle time can be shortened (see a left drawing of FIG. 6).

Alternatively, when the tool position in the subsequent control cycle is located within the vicinity of the interference area, the distance determination unit 103 causes the in-position width command unit 108 to output Iin as the in-position width in the subsequent control cycle. On the other hand, when the tool position in the subsequent control cycle is located outside the vicinity of the interference area, the in-position width command unit 108 is caused to output Iout as the in-position width in the subsequent control cycle. In this way, in the vicinity of the interference area, the in-position width is set to be small when compared to the outside of the vicinity of the interference area, and thus a gap due to a servo delay becomes small, and interference can be avoided. Alternatively, even when interference occurs, damage at the time of interference can be suppressed. On the other hand, on the outside of the vicinity of the interference area, the in-position width is set to be large when compared to the vicinity of the interference area, and thus a cycle time can be shortened (see a right drawing of FIG. 6).

The in-position width output by the in-position width command unit 108 and the feed speed override output by the feed speed override command unit 109 are used in processing of step 2 in the subsequent control cycle.

The numerical controller 1 according to Example 1 sets at least one of the feed speed override and the in-position width to be relatively small when the tool is present in the vicinity of the interference area. This scheme has an advantage that the feed speed override or the in-position width can be determined based only on a position of the tool, and speed control can be easily realized by considering the interference area.

### Example 2

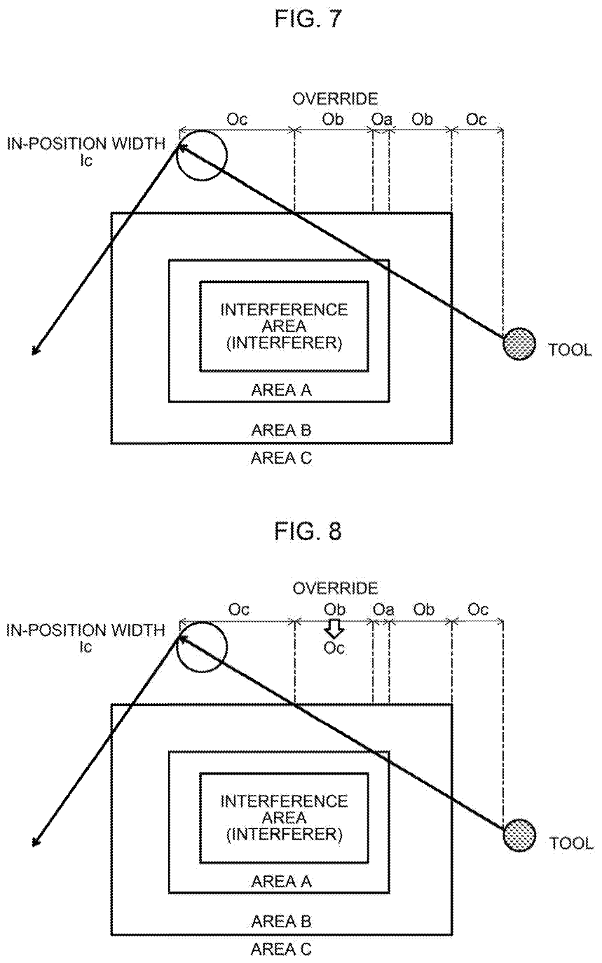

FIG. 7 is a diagram illustrating an outline of an operation of the numerical controller 1 in Example 2. The numerical controller 1 according to Example 2 is characterized in that a plurality of areas is set in accordance with the distance from the interference area, and at least one of the feed speed override and the in-position width is controlled for each area. That is, Example 2, as an area in which the tool is present is closer to the interference area, at least one of the feed speed and the in-position width is set to be smaller.

The operation of the numerical controller 1 will be described over time according to FIG. 4. The numerical controller 1 repeatedly executes processing of step 1 to step 3 for each control cycle. A description of apart that operates the same as in Example 1 will be omitted as appropriate.

Step 1: The preprocessor 101 reads a program from the non-volatile memory 14, etc. and interprets the program.

Step 2: The interpolation movement command distribution processing unit 104 performs interpolation processing and axis distribution processing. In this instance, when the in-position width output by the in-position width command unit 108 and the feed speed override output by the feed speed override command unit 109 can be obtained, the interpolation movement command distribution processing unit 104 reflects the in-position width and the speed override in the movement command.

In response thereto, the servomotor 50 of each axis of the machine is driven by the movement command output unit 105 and the acceleration/deceleration processing unit 106.

Step 3: In parallel to processing of step 2, the leading position computation unit 102 pre-reads the program and computes the tool position in the subsequent control cycle.

The distance determination unit 103 controls at least one of the feed speed and the in-position width in accordance with an area in which the tool position in the subsequent control cycle is present. An example of a specific control scheme is shown.

In the present example, as in FIG. 7, two or more areas having different distances from the interference area are defined on the outside of the interference area. For example, an area A is defined immediately outside the interference area, an area B is defined outside the area A, and an area C is defined outside the area B. In this case, it is presumed that the distance determination unit 103 retains a feed speed override Oa and an in-position width Ia corresponding to a case in which the tool position is in the area A, a feed speed override Ob and an in-position width Ib corresponding to a case in which the tool position is in the area B, and a feed speed override Oc and an in-position width Ic corresponding to a case in which the tool position is in the area C in a database, a setting file, etc. in advance. Here, Oa<Ob<Oc and Ia<Ib<Ic.

In addition, it is presumed that the distance determination unit 103 specifies the interference area, the area A, the area B, and the area C in advance. For example, the distance determination unit 103 specifies the interference area similarly to Example 1. Further, each of the area A obtained by adding a margin Ma to the periphery of the interference area, the area B obtained by adding a margin Mb to a periphery of the area A, and the area C outside the area B is computed.

The distance determination unit 103 outputs the feed speed override Oa in a case in which the tool position in the subsequent control cycle is within the area A, the feed speed override Ob in a case in which the tool position is within the area B, and the feed speed override Oc in a case in which the tool position is within the area C as the feed speed override in the subsequent control cycle to the feed speed override command unit 109. In this way, in an area closer to the interference area, a smaller feed speed is set, and thus a gap due to a servo delay becomes small, and it is easier to avoid interference. Alternatively, even when interference occurs, damage at the time of interference can be further suppressed. On the other hand, in an area farther from the interference area, a feed speed is set to be larger, and thus a cycle time can be further shortened.

Alternatively, the distance determination unit 103 outputs the in-position width Ia in a case in which the tool position in the subsequent control cycle is within the area A, the in-position width Ib in a case in which the tool position is within the area B, and the in-position width Ic in a case in which the tool position is within the area C as the in-position width in the subsequent control cycle to the in-position width command unit 108. In this way, in an area closer to the interference area, a smaller in-position width is set, and thus a gap due to a servo delay becomes small, and it is easier to avoid interference. Alternatively, even when interference occurs, damage at the time of interference can be further suppressed. On the other hand, in an area farther from the interference area, an in-position width is set to be larger, and thus a cycle time can be further shortened.

The in-position width output by the in-position width command unit 108 and the feed speed override output by the feed speed override command unit 109 are used in processing of step 2 in the subsequent control cycle.

The numerical controller 1 according to Example 2 sets at least one of the feed speed and the in-position width smaller as the area in which the tool is present is closer to the interference area. This scheme is advantageous in that the feed speed override or the in-position width can be determined based only on the position of the tool, and finer speed control than that in Example 1 can be realized.

### Example 3

FIG. 8 is a diagram illustrating an outline of an operation of the numerical controller 1 in Example 3. When the tool moves in a direction in which a distance from the interference area increases, the numerical controller 1 according to Example 3 sets the feed speed override or the in-position width larger than the value computed in Example 1 or Example 2. Preferably, control for reducing the feed speed override or the in-position width is not performed at all.

The operation of the numerical controller 1 will be described over time according to FIG. 4. A description will be given in comparison with Example 2. However, a description of a part that operates the same as in Example 2 will be omitted as appropriate.

Step 1 and step 2: The numerical controller 1 operates similarly to Example 2.

Step 3: As in Example 2, the numerical controller 1 sets at least one of the feed speed and the in-position width to be smaller as the area in which the tool is present is closer to the interference area. That is, the feed speed override Oa and the in-position width Ia are set when the tool position in the subsequent control cycle is within the area A, the feed speed override Ob and the in-position width Ib are set when the tool position is within the area B, and the feed speed override Oc and the in-position width Ic are set when the tool position is within the area C. Here, Oa<Ob<Oc and Ia<Ib<Ic.

When the tool moves in the direction in which the distance from the interference area increases, the distance determination unit 103 of the numerical controller 1 performs setting to a largest value that can be changed regardless of setting of the feed speed override or the in-position width described above. For example, in an example illustrated in FIG. 8, the tool moves from area C→area B→area A→area B (second time)→ . . . . Among these areas, in the area B (second time), the tool moves in the direction in which the distance from the interference area increases, that is, a direction away from the interference area. In this case, the distance determination unit 103 sets the feed speed override or the in-position width to a maximum value. That is, even though the feed speed override in the area B (second time) is Ob according to Example 2, the feed speed override is changed to Oc (Ob<Oc) corresponding to a maximum value that can be changed in the present example.

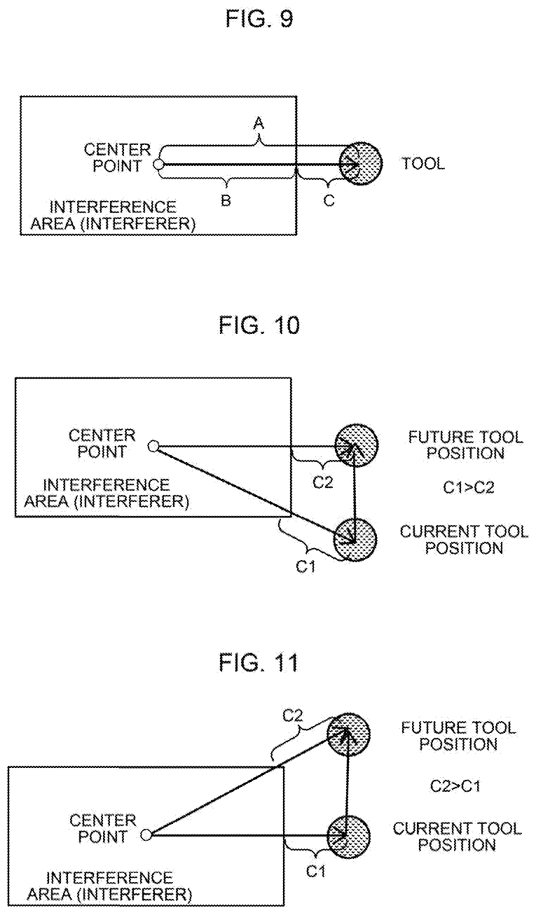

The distance determination unit 103 can determine whether the tool moves in the direction in which the distance from the interference area increases by processing shown in, for example, FIG. 9 to FIG. 11 and step (1) to step (3).

Step (1): The distance determination unit 103 acquires a current tool position and a tool position in the subsequent control cycle. The current position of the tool can be acquired from the current position register 110. The tool position in the subsequent control cycle is computed by the leading position computation unit 102.

Step (2): The distance determination unit 103 obtains a distance C1 between the interference area and the current tool position and a distance C2 between the interference area and the tool position in the subsequent control cycle.

A description will be given of a scheme of obtaining a distance C between the interference area and the tool position with reference to FIG. 9. The distance determination unit 103 obtains a linear distance A from a center point of the interference area (center of the interference area) to the tool position. Subsequently, a distance B from the center point of the interference area to an outer edge (boundary) of the interference area is obtained. A distance C can be computed by subtracting B from A.

Step (3): The distance determination unit 103 compares the distance C1 between the interference area and the current tool position with the distance C2 between the interference area and the tool position in the subsequent control cycle. When C1>C2, it is determined that the tool moves in a direction in which the distance from the interference area decreases (see FIG. 10). On the other hand, when C1<C2, it is determined that the tool moves in the direction in which the distance from the interference area increases (see FIG. 11).

When the tool moves in the direction in which the distance from the interference area increases, the numerical controller 1 according to Example 3 does not perform control to reduce the feed speed or the in-position width in accordance with the distance from the interference area. A reason therefor is that it is considered that no interference occurs when the tool moves away from the interference area. In this way, it is possible to further shorten the cycle time.

Even though embodiments of the application have been described above, the application can be implemented in various aspects by adding an appropriate change without being limited only to embodiments described above.

For example, in the above-described embodiments, one or a plurality of areas are set in accordance with the distance from the interference area, and the feed speed override or the in-position width is determined depending on the area in which the tool is located among the areas. However, the application is not limited thereto, and the feed speed or the in-position width may be determined by another calculation scheme based on the distance from the interference area. For example, the distance determination unit 103 may retain a correspondence relationship between the distance C between the interference area and the tool position (see FIG. 9) and the feed speed override or in-position width in the form of a formula or a table. In this case, the distance determination unit 103 can first compute the distance C, and obtain the feed speed override or the in-position width corresponding to the distance C computed in light of the correspondence relationship.

In addition, the above embodiments mainly discuss a relationship between the tool and the interference area. However, the application is not limited to the tool, and may be applied to a relationship between any movable object (typically attached to a spindle and moved) and the interference area.

1. A numerical controller for moving a movable object by axis control, the numerical controller comprising
a distance determination unit for setting at least one of a feed speed or an in-position width in accordance with a distance between an interference area where entry of the movable object is prohibited and the movable object.

2. The numerical controller according to claim 1, wherein the distance determination unit sets a feed speed override or an in-position width to be smaller in a case in which the movable object is located in a vicinity of the interference area provided in a certain range of a periphery of the interference area than in a case in which the movable object is located outside the vicinity of the interference area.

3. The numerical controller according to claim 1, wherein the distance determination unit provides a plurality of areas having different distances from the interference area in a periphery of the interference area, and sets a feed speed override or an in-position width to be smaller as an area in which the movable object is located is closer to the interference area.

4. The numerical controller according to claim 1, wherein the distance determination unit determines a movement direction of the movable object on the basis of a current position of the movable object and a position of the movable object in a subsequent control cycle, and sets at least one of the feed speed or the in-position width in accordance with the movement direction.

5. The numerical controller according to claim 4, wherein when the movable object moves in a direction in which a distance from the interference area increases, the distance determination unit does not perform setting for the feed speed or the in-position width.

6. The numerical controller according to claim 4, wherein when the movable object moves in a direction in which a distance from the interference area decreases, the distance determination unit sets the feed speed override or the in-position width to be smaller as the distance is smaller.
